(19) United States
(12) Patent Application Publication
(10) Pub. No.: US 2016/0377182 A1
(43) Pub. Date: Dec. 29, 2016

(54) ROTARY SHAFT SEAL

(71) Applicants: Mark K. Zitting, Draper, UT (US); Daniel Paul Hurst, West Jordan, UT (US); Raymond Lee Chaplin, Draper, UT (US)

(72) Inventors: Mark K. Zitting, Draper, UT (US); Daniel Paul Hurst, West Jordan, UT (US); Raymond Lee Chaplin, Draper, UT (US)

(73) Assignee: AKTIEBOLAGET SKF, GOTEBORG (SE)

(21) Appl. No.: 14/748,812

(22) Filed: Jun. 24, 2015

(51) Int. Cl. F16J 15/34

(52) U.S. Cl. CPC F16J 15/3456; F16C 3/02

(57) ABSTRACT

A rotary seal and rotary machine incorporating such a rotary seal. The rotary seal includes a first race defining a plurality of grooves, and a second race defining a plurality of sealing lips. The plurality of sealing lips are disposed in the plurality of grooves such that a compound seal is formed between the first and second races, and the first race and the second race are relatively rotatable.

### BACKGROUND

Rotary shaft seals are generally positioned between a stationary housing and a rotating member, such as a shaft, or between two relatively rotatable structures. Such seals generally include a cylindrical outer covering that forms an interference fit with the housing, and a sealing lip made of an elastomeric or thermoplastic material that seals dynamically and statically against the shaft. The lip is normally pressed against the surface of the shaft, e.g., by a garter spring, to effect such sealing.

There are many applications for such seals. For example, the seals may be used to protect bearings that support the shaft in the housing. As such, the seals may serve to retain grease and/or other lubricant in contact with the bearings. The rotary shaft seals also serve to minimize dirt, oil, and water contact with the bearings, which may damage and cause premature failure of the bearings and/or other components.

At high speeds and/or high pressures, the contacting, generally elastomeric elements can wear quickly, which may result in short lifecycles and/or frequent maintenance requirements.

### SUMMARY

Embodiments of the disclosure may provide a rotary seal including a first race defining a plurality of grooves, and a second race defining a plurality of sealing lips. The plurality of sealing lips are disposed in the plurality of grooves such that a compound seal is formed between the first and second races, and the first race and the second race are relatively rotatable.

Embodiments of the disclosure may also provide a rotary machine including a housing, a rotatable shaft disposed at least partially within the housing, a bearing transmitting a weight of the shaft to the housing, and a rotary seal disposed adjacent to the bearing. The rotary seal includes an inner race coupled with the shaft and rotatable therewith, the inner race defining a plurality of grooves. The rotary seal also includes an outer race sealed with the housing, the inner and outer races being relatively rotatable, and the outer race defining a plurality of sealing lips, wherein the plurality of sealing lips are disposed in the plurality of grooves such that a compound seal is formed between the inner and outer races.

It will be appreciated that the foregoing summary is intended merely to introduce certain aspects of the disclosure. These and other aspects are more fully described below. As such, this summary is not intended to be limiting on the claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a perspective, sectional view of a rotary seal, according to an embodiment.

FIG. 2 illustrates a cross-sectional view of the rotary seal, according to an embodiment.

FIG. 3 illustrates an enlarged view of a portion of the cross-sectional view of FIG. 2, according to an embodiment.

FIG. 4 illustrates a conceptual cross-sectional view of a rotary machine including the rotary seal, according to an embodiment.

FIG. 5 illustrates a cross-sectional view of another rotary seal, according to an embodiment.

FIG. 6 illustrates a cross-sectional view of still another rotary seal, according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

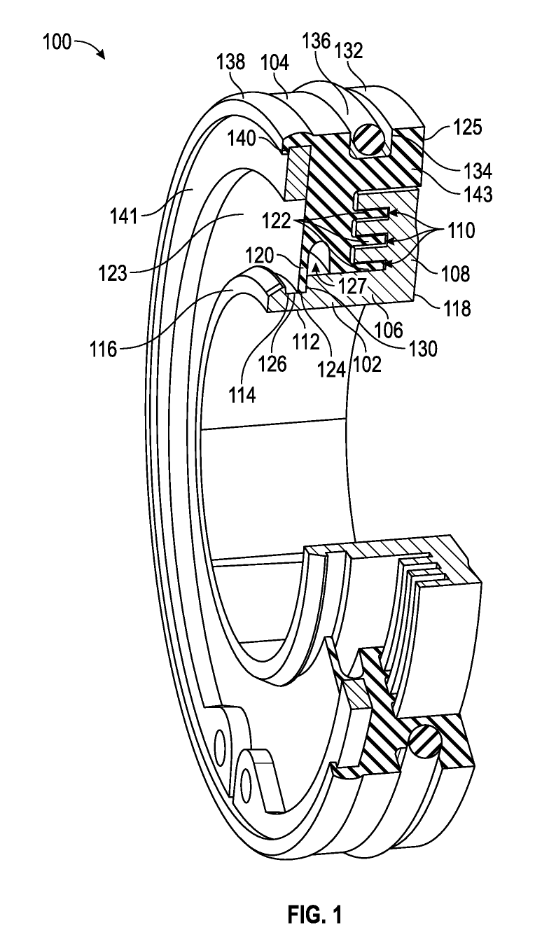

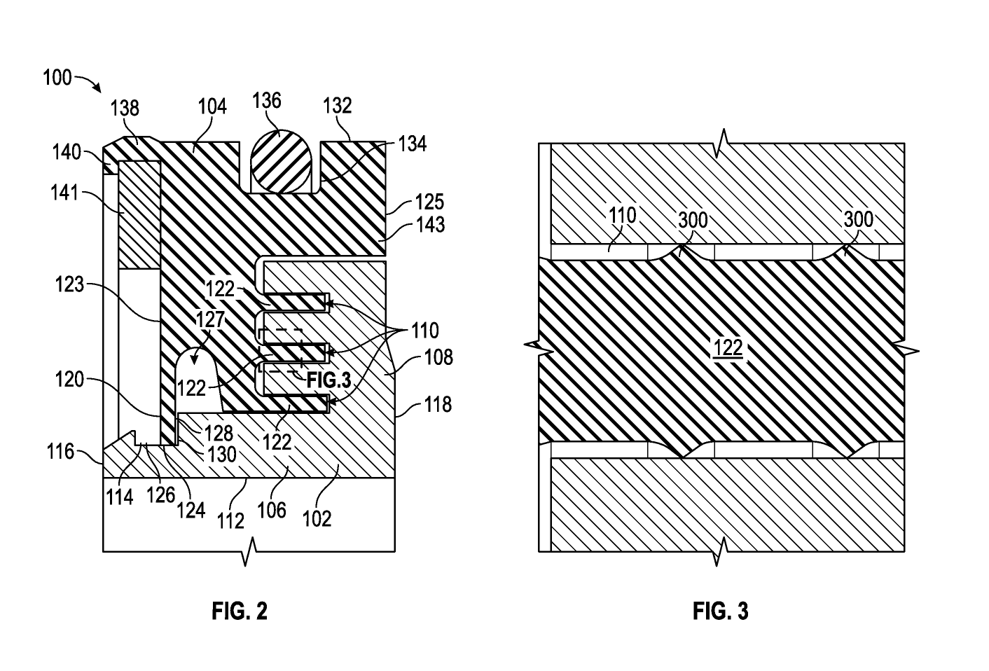

FIG. 1 illustrates a perspective, sectional view of a rotary seal 100, according to an embodiment. FIG. 2 illustrates a cross-sectional view of the rotary seal 100, according to an embodiment. Referring to FIGS. 1 and 2, the rotary seal 100 generally includes a first race 102 and a second race 104. In the following description, the first race 102 may be referred to as the inner race 102, and the second race 104 may be referred to as the outer race 104; however, it will be appreciated that the relative positioning of the first and second races 102, 104 may be swapped, such the first race 102 extends to a position that is radially outward of the second race 104.

The inner race 102 may be coupled with a shaft and may be rotatable therewith. Further, the inner race 102 may be made at least partially from a metal or alloy. The outer race 104 may be generally stationary with respect to the inner race 102 and may be made at least partially from an elastomer, a polymer, or the like. In a specific embodiment, the outer race 104 may be at least partially made from polytetrafluoroethylene (PTFE). The outer race 104, further, may be coupled with and may seal with a housing or another structure, which may support the shaft via one or more radial and/or axial bearings.

In an embodiment, the inner race 102 may include a main body 106, a radial extension 108, and a plurality of axially-extending grooves 110. The main body 106 may define an inner diameter 112 of the rotary seal 100. In an embodiment, the main body 106 may also define a radially-extending groove 114 therein. A first end 116 of the main body 106, e.g., proximal to the groove 114, as shown, may be tapered, which may facilitate installation of the outer race 104, as will be described in greater detail below. The radial extension 108 may extend outwards from the main body 106, e.g., proximal to a second end 118 thereof. Further, the axially-extending grooves 110 may extend into the radial extension 108, e.g., in an axial direction generally toward the second end 118 of the main body 106.

The outer race 104 may include a radial sealing lip 120 and a plurality of axial sealing lips 122. Further, the outer race 104 may define first and second axial ends 123, 125 at the axial extents thereof. The radial sealing lip 120 may be positioned at the first axial end 123 and may be defined by a recess 127 formed in the outer race 104, which may provide a degree of flexibility to the radial sealing lip 120. This may facilitate installation of the outer race 104 onto the inner race 102, and may result in an empty region defined by the recess 127. During such installation, the radial sealing lip 120 may be received over the tapered first end 116 and into the groove 114, so as to seal or form a barrier closely proximate with the main body 106. Further, the radial sealing lip 120 may be formed from a resilient material (e.g., a polymer, an elastomer, or a combination thereof), such that the radial sealing lip 120 may flex in at least one axial direction to allow the radial sealing lip 120 to clear the first end 116 during assembly.

In some embodiments, an inner diameter 124 of the radial sealing lip 120 may contact the main body 106, e.g., at an inner surface 126 of the groove 114. In other embodiments, the inner diameter 124 may be closely proximate to the inner surface 126, but may be spaced apart therefrom. Further, a side 128 of the radial sealing lip 120 contact a side 130 of the groove 114, but in other embodiments, may be proximate, but not in contact, therewith.

An outer diameter 132 of the outer race 104 may define a seal groove 134 therein. The seal groove 134 may be configured to receive a sealing element 136 therein, such as an O-ring, which may facilitate the formation of a fluid-tight seal between the outer race 104 and a housing or other structure in which the rotary seal 100 is employed.

The outer race 104 may also define a snap-ring hook 138, which may include a lip 140. The snap-ring hook 138 may extend from the first end 123 of the outer race 104, while the lip 140 may extend radially inwards. A relatively-rigid (in comparison to the outer race 104) snap ring 141 may be received into engagement with the snap-ring hook 138, and may be retained in engagement with the outer race by the lip 140, so as to enhance the strength of the outer race 104. At the second end 125, the outer race 104 may define a shoulder 143 which may extend radially inwards from the outer diameter 132.

The axial lips 122 may be positioned proximal to the axial middle of the outer race 104, and may extend toward the second end 125 thereof. In an embodiment, the axial lips 122 may be axially aligned, as shown, but in others may be staggered, offset, or otherwise positioned relative to one another. Further, the axial lips 122 may be offset radially from one another. The offset distance may be uniform or different as between pairs of adjacent axial lips 122.

During assembly, as shown, the axial lips 122 of the outer race 104 may be received into the axial grooves 110 of the inner race 102. In some embodiments, the axial lips 122 may extend axially into engagement with the radial extension 108, e.g., at the end of the axial groove 110. In others, the axial lips 122 may extend a shorter distance than the axial grooves 110.

FIG. 3 illustrates an enlarged, cross-sectional view of a portion of FIG. 2, as indicated in FIG. 2, according to an embodiment. In particular, FIG. 3 shows an example of one of the axial lips 122 of the outer race 104 received into an axial groove 110 of the inner race 102. As shown, the axial lip 122, which may be made of a relatively soft and/or resilient material (e.g., a polymer such as PTFE, an elastomer, etc., as mentioned above), may define one or more alignment features 300. The alignment features 300 may be formed as protrusions extending radially outwards and/or radially inwards from the axial lip 122. The alignment features 300 may be generally flexible, so as to deflect across a range of positions, allowing the axial lips 122 to resiliently engage the inner race 104 in the groove 110 with a relatively small surface area. This may reduce wear to and generally facilitate the inner and outer races 102, 104 maintaining alignment during use. In some embodiments, the alignment features 300 may extend as rings or as a helix along a surface of the axial lips 122. In another embodiment, the alignment features 300 may be or be similar to knurls, forming discrete peaks through at least a portion of the axial lips 122. These features 300 may be spaced and staggered differently, e.g., to keep flexibility in the alignment feature. For example, the outer radial alignment features 300 may be offset axially from the inner radial alignment features.

Referring to FIGS. 1-3, operation of the rotary seal 100 may be appreciated. The rotary seal 100 provides a compound, substantially contactless seal between the inner and outer races 102, 104. In this context, “substantially contactless” means that the two races 102, 104 do not touch in order to form a seal, although some incidental contact may occur. The seal between the inner and outer races 102, 104 may also be considered compound, as the sealing provided by the radial lip 120 is bolstered by the labyrinth-type seal provided by axial lips 122 received into the axial grooves 110. Furthermore, the alignment features 300, when provided, may further enhance this labyrinth-type seal, e.g., by provide a plurality of pressure drops along each of the axial lips 122 (e.g., in a ring or helix embodiment of the alignment features 300).

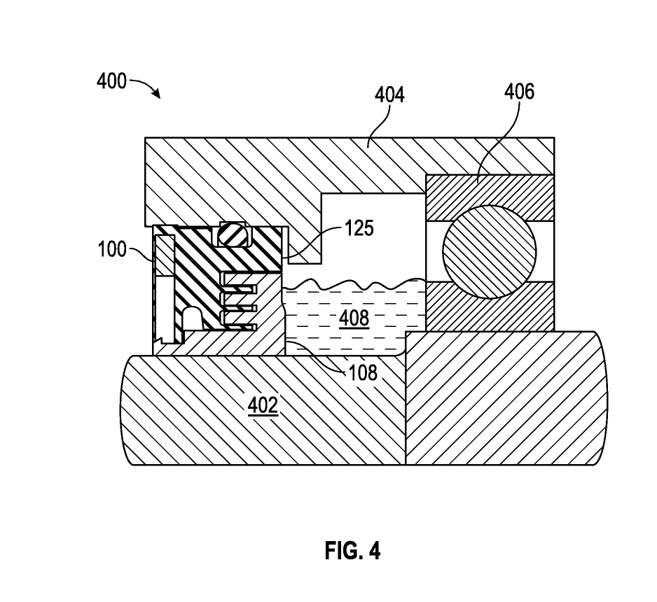

FIG. 4 illustrates a partial, cross-sectional view of a rotary machine 400 including the rotary seal 100, according to an embodiment. The rotary machine 400 may be any type of machine with a rotatable member that may be sealed. As shown, the rotary machine 400 may include a shaft 402, which may be an example of such a rotatable member. In particular, the shaft 402 may be rotatable relative to a housing 404, which may be an example of a “stationary” member (i.e., stationary relative to the rotatable shaft 402).

The shaft 402 may be supported in the housing 404 by a bearing 406, such as a roller bearing. The bearing 406 may be provided with a lubricant (e.g., grease, oil, etc.) 408. The lubricant 408 may form a film within the bearing 406 and may be prevented from migrating away from the bearing 406 by the rotary seal 100. As shown, the second ends 118, 125 of the inner and outer races 102, 104, respectively, may face toward the bearing 406.

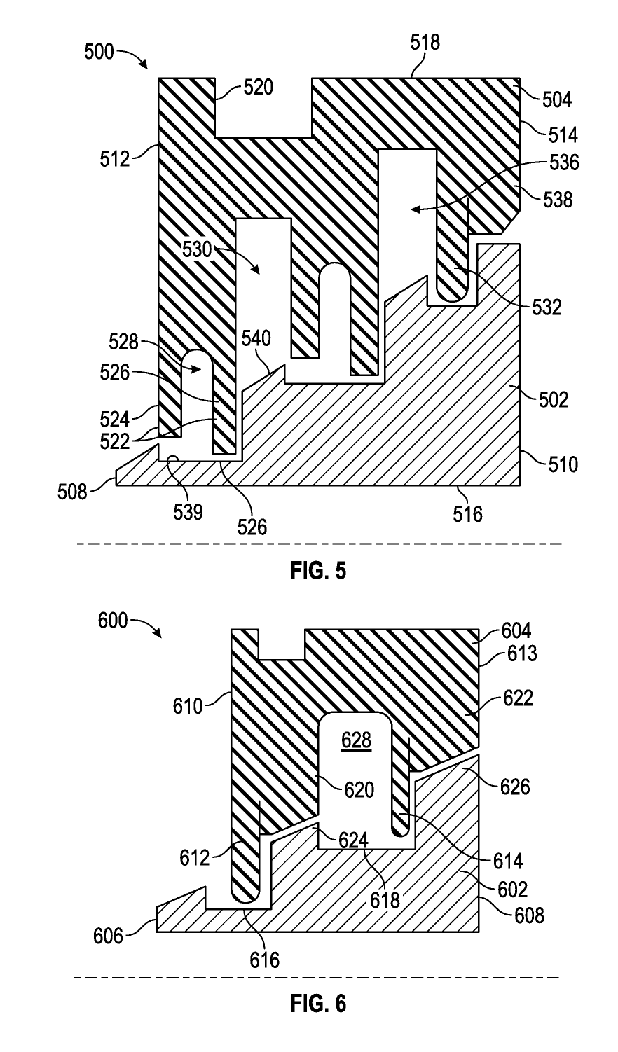

FIG. 5 illustrates a cross-sectional view of another rotary seal 500, according to an embodiment. The seal 500 includes the inner race 502 and the outer race 504. The inner race 502 may be at least partially constructed from a metal or alloy, and the outer race 504 may be at least partially constructed from a polymer, elastomer, or the like, e.g., PTFE. Further, the inner race 502 may define first and second axial ends 508, 510, and the outer race 504 may define first and second axial ends 512, 514. An inner diameter 516 of the inner race 502 may be configured to be coupled with a shaft or another rotary member, while an outer diameter 518 of the outer race 504 may be coupled (e.g., sealed) with a housing or another stationary or rotatable member. In an embodiment, the outer diameter 518 may define a groove 520 therein, for receiving a sealing element (e.g., O-ring), as previously described.

The outer race 504 may include a plurality of first radially-extending lips 522, which may be constructed at least partially from PTFE or another polymer or elastomer. The first radially-extending lips 522 may be positioned in pairs, with the pairs including a trailing lip 524 and a leading lip 526. In an embodiment, the leading lip 526 may extend farther radially inward than the trailing lip 524 of the same pair. A first pocket 528 may be formed between each pair of trailing and leading lips 524, 526. A second pocket 530 may be formed between the leading lip 526 of one of the pairs and the trailing lip 524 of another of the pairs. The pockets 528, 530 may allow the lips 522 to flex, e.g., during installation and/or operation, and may also serve as a reservoir for any grease, oil, water, or contaminants that may begin to migrate between the inner and outer races 502, 504.

The outer race 504 may also define a second radially-extending lip 532, e.g., proximal to the second end 514, which may be separated from the leading lip 526 of one of the first lips 522 by a third pocket 536. A back-up rib 538 may be defined adjacent to the second lip 532, e.g., opposite from the third pocket 536, and may serve to reduce deflection of the second lip 532 in one axial direction (i.e., towards the back-up rib 538).

The inner race 502 may define a plurality of grooves 539. The pairs of leading lips 526 and trailing lips 524 may be received in individual ones of the plurality of grooves 539. As mentioned above, the leading lip 526 of each pair of the first lips 522 may extend farther radially inward than the trailing lip 524 of the pair. Accordingly, the leading lip 526 may extend closer to the bottom of the groove 520 in which the first lips 522 are disposed. Further, the second lip 532 may be received in one of the plurality of grooves 539.

The inner race 502 may also include tapered partitions 540 between the grooves 539, with the tapered partitions 540 extending radially outward as proceeding toward the second end 510. Further, the grooves 539 may be positioned progressively farther radially outward, as proceeding to the second end 510. Accordingly, the first lips 522 and the second lip 532 may also be positioned farther radially outwards. This configuration may allow the outer race 504 to be assembled onto the inner race 502 by sliding the outer race 504 toward the second end 510 of the inner race 502. In particular, as the outer race 504 moves, relative to the inner race 502, toward the second end 510 thereof, the leading lips 526 and the second lip 532 may deflect against the tapered partition 540 adjacent to the groove 539 in which each of the respective lips 522, 532 are to be positioned. Continued movement of the outer race 504 relative to the inner race 502 may cause the lips 526, 532 to deflect, before reaching the grooves 539. In some embodiments, the trailing lips 524 may not deflect, but may be positioned sufficiently radially outwards so as to clear the partitions 540

It will be appreciated that relative movement of the outer race 504 with respect to the inner race 502 encompasses situations in which the outer race 504 moves and the inner race 502 is stationary, both the inner and outer races 502, 504 move, and the outer race 504 is held stationary while the inner race 502 is moved.

FIG. 6 illustrates a cross-sectional view of another rotary seal 600, according to an embodiment. The rotary seal 600 includes an inner race 602 and an outer race 604. The inner race 602 may be formed at least partially from a metal or an alloy, and the outer race 604 may be at least partially formed from a polymer (e.g., PTFE), an elastomer, or both. The inner race 602 may define a first axial end 606 and a second axial end 608. The second axial end 608 may face toward a bearing (i.e., the second axial end 608 may be the lubricant side of the inner race 602). The outer race 602 may define a first axial end 610 and a second axial end 613.

The outer race 604 may also define radial lips 612, 614, which may be disposed in grooves 616, 618 defined in the inner race 602, respectively. The outer race 604 may also include back-up ribs 620, 622 that may be disposed adjacent to the radial lips 612, 614. The back-up ribs 620, 622 may be tapered along a radial inside surface thereof. The inner race 602 may define tapered partitions 624, 626, which may be tapered at a complementary slope to the tapered radial inside surface of the back-up ribs 620, 622.

The outer race 604 may also define a pocket 628 between the lips 612, 614, e.g., between the back-up rib 620 and the radial lip 614. Accordingly, the radial lips 612, 614 may be flexible in one axial direction, but may be prevented from flexing in an opposite axial direction (e.g., towards the second end 613) by the back-up ribs 620. This one-way flexing may allow the outer race 604 to be slid over the inner race 602, while preventing the lips 612, 614 from engaging the inner race 602 in the grooves 616, 618. The pocket 628 may also serve as a reservoir for any grease, oil, water, or contaminants that may begin to migrate between the inner and outer races.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A rotary seal, comprising:
a first race defining a plurality of grooves; and
a second race defining a plurality of sealing lips, wherein the plurality of sealing lips are disposed in the plurality of grooves such that a compound seal is formed between the first and second races, and wherein the first race and the second race are relatively rotatable.

2. The rotary seal of claim 1, wherein the plurality of sealing lips are positioned so as to be spaced apart from the first race in the plurality of grooves, such that the compound seal is substantially contactless.

3. The rotary seal of claim 1, wherein the first race is at least partially constructed from a metal, a metal alloy, or both, and wherein the plurality of sealing lips are at least partially constructed from an elastomer, a polymer, or both.

4. The rotary seal of claim 1, wherein the plurality of grooves comprises a plurality of axially-extending grooves that are radially offset from one another, and wherein the plurality of sealing lips comprises a plurality of axially-extending sealing lips configured to be disposed within the plurality of axially-extending grooves.

5. The rotary seal of claim 4, wherein the plurality of grooves further comprises a radially-extending groove, and wherein the plurality of sealing lips comprises a radially-extending lip that is disposed in the radially-extending groove, the radially-extending groove being axially offset from the plurality of axially-extending grooves.

6. The rotary seal of claim 4, wherein the plurality of axially-extending sealing lips comprises one or more alignment features configured to resiliently engage the first race in the plurality of axially-extending grooves.

7. The rotary seal of claim 6, wherein the one or more alignment features comprise one or more radially-extending protrusions, and wherein each of the one or more alignment features is configured to create a pressure drop in a fluid.

8. The rotary seal of claim 1, wherein the plurality of sealing lips comprises a plurality of radially-extending lips that are axially offset from one another.

9. The rotary seal of claim 8, wherein the plurality of radially-extending lips comprises a leading lip and a trailing lip, the leading lip and the trailing lip being disposed in one of the plurality of grooves and separated apart by a pocket defined in the second race.

10. The rotary seal of claim 9, wherein the leading lip extends farther into the one of the plurality of grooves than does the trailing lip.

11. The rotary seal of claim 8, wherein the second race comprises a back-up rib disposed adjacent to at least one of the plurality of radially-extending lips, to limit a flexibility of the at least one of the plurality of radially-extending lips in at least one axial direction.

12. The rotary seal of claim 11, wherein the back-up rib defines a tapered surface, and wherein the first race includes a tapered partition adjacent to at least one of the grooves, the tapered surface of the back-up rib being aligned with and extending at a complementary angle to the tapered partition.

13. The rotary seal of claim 1, wherein an inner diameter of the first race is coupled with a shaft and an outer diameter of the second ring is coupled with a housing.

14. The rotary seal of claim 1, further comprising a snap ring coupled with the first race.

15. The rotary seal of claim 14, wherein the first race comprises a snap-ring hook and a radially-extending snap-ring lip, the snap ring being received into the snap-ring hook and retained by the snap-ring lip.

16. A rotary machine, comprising:
a housing;
a rotatable shaft disposed at least partially within the housing;
a bearing transmitting a weight of the shaft to the housing; and
a rotary seal disposed adjacent to the bearing, comprising:
an inner race coupled with the shaft and rotatable therewith, the inner race defining a plurality of grooves; and
an outer race sealed with the housing, the inner and outer races being relatively rotatable, and the outer race defining a plurality of sealing lips, wherein the plurality of sealing lips are disposed in the plurality of grooves such that a compound seal is formed between the inner and outer races.

17. The rotary machine of claim 16, wherein the plurality of sealing lips are positioned so as to be spaced apart from the inner race in the plurality of grooves, such that the compound seal is substantially contactless.

18. The rotary machine of claim 16, wherein the inner race is at least partially constructed from a metal, a metal alloy, or both, and wherein the plurality of sealing lips are at least partially constructed from an elastomer, a polymer, or both.

19. The rotary machine of claim 16, wherein the plurality of grooves comprises a plurality of axially-extending grooves that are radially offset from one another, and wherein the plurality of sealing lips comprises a plurality of axially-extending sealing lips configured to be disposed within the plurality of axially-extending grooves.

20. The rotary machine of claim 16, wherein the plurality of sealing lips comprise a plurality of radially-extending lips that are axially offset from one another, and wherein the plurality of grooves comprise a plurality of radially-extending grooves, the plurality of radially-extending grooves being positioned progressively farther radially outwards as proceeding toward an end of the rotary seal that faces the bearing.
